(19) United States
(12) Patent Application Publication
(10) Pub. No.: US 2026/0172557 A1
(43) Pub. Date: Jun. 18, 2026

(54) MULTIPLE TRANSFORM SELECTION CORE SUPPORT FOR INTER PREDICTION BLOCKS IN MOTION PREDICTION

(71) Applicant: Alibaba (China) Co., Ltd., Hangzhou (CN)

(72) Inventors: Ru-ling Liao, Sunnyvale, CA (US); Yan Ye, San Diego, CA (US); Jie Chen, Beijing (CN); Xinwei Li, Beijing (CN)

(21) Appl. No.: 19/390,320

(22) Filed: Nov. 14, 2025

Related U.S. Application Data
(60) Provisional application No. 63/733,967, filed on Dec. 13, 2024.

(51) Int. Cl. H04N 19/12; H04N 19/159; H04N 19/184; H04N 19/196; H04N 19/61

(52) U.S. Cl. CPC H04N 19/12; H04N 19/159; H04N 19/184; H04N 19/196; H04N 19/61

(57) ABSTRACT

A VVC-standard encoder and a VVC-standard decoder are provided, configuring one or more processors of a computing system to apply additional transform cores for inter coded blocks and apply a decoder side intra mode derivation (“DIMD”) process to inter prediction samples or residual samples to derive an intra prediction angular mode.

### RELATED APPLICATIONS

This application claims the benefit of U.S. Patent Application No. 63/733,967, entitled “MULTIPLE TRANSFORM SELECTION CORE SUPPORT FOR INTER PREDICTION BLOCKS IN MOTION PREDICTION” and filed Dec. 13, 2024, which is expressly incorporated herein by reference in its entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET developed further techniques beyond the scope of the VVC standard under the Enhanced Compression Model (“ECM”) name, which has formed the basis for the successor H.267 standard currently in draft status.

According to VVC and later standards, an encoder and a decoder partition picture data into blocks, and perform motion prediction upon luma and chroma components of the blocks by selecting one among various intra prediction and inter prediction modes. VVC and later standards implement a multiple transform selection (“MTS”) for core transform, wherein three transform types are allowed: two Discrete Cosine Transforms (DCT-II and DCT-VIII) and one Discrete Sine Transform (DST-VII). A flag at the coding unit (“CU”) level is signaled to indicate whether MTS is applied, along with two additional flags to indicate the transform type for the horizontal and vertical directions, respectively.

Moreover, at time of writing, the latest draft of ECM (presented at the 39th meeting of the JVET in October 2025 as “Algorithm description of Enhanced Compression Model 19 (ECM 19)”) includes proposals to further implement MTS. There is a need to further improve the capabilities of MTS over the functionality provided by VVC and later standards and by ECM.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIG. 2 illustrates 67 intra prediction angular modes provided by VVC and later standards.

FIG. 3 illustrates intra prediction angular mode derivation applied to inter prediction samples or residual samples to derive an intra prediction angular mode according to example embodiments of the present disclosure.

FIG. 4 illustrates adding additional MTS candidates in sequence parameter set (“SPS”) syntax according to amplitude, according to example embodiments of the present disclosure.

FIG. 5 illustrates replacing MTS candidates in SPS syntax according to amplitude, according to example embodiments of the present disclosure.

FIG. 6 illustrates signaling by flag to indicate whether a DIMD process has been applied to inter coded blocks according to example embodiments of the present disclosure.

FIG. 7 illustrates an example system for implementing the processes and methods described herein for implementing multiple transform selection for inter coded blocks.

### DETAILED DESCRIPTION

Systems and methods discussed herein are directed to implementing multiple transform selection for inter coded blocks, and more specifically applying additional transform cores for inter coded blocks and applying a decoder side intra mode derivation (“DIMD”) process to inter prediction samples or residual samples to derive an intra prediction angular mode.

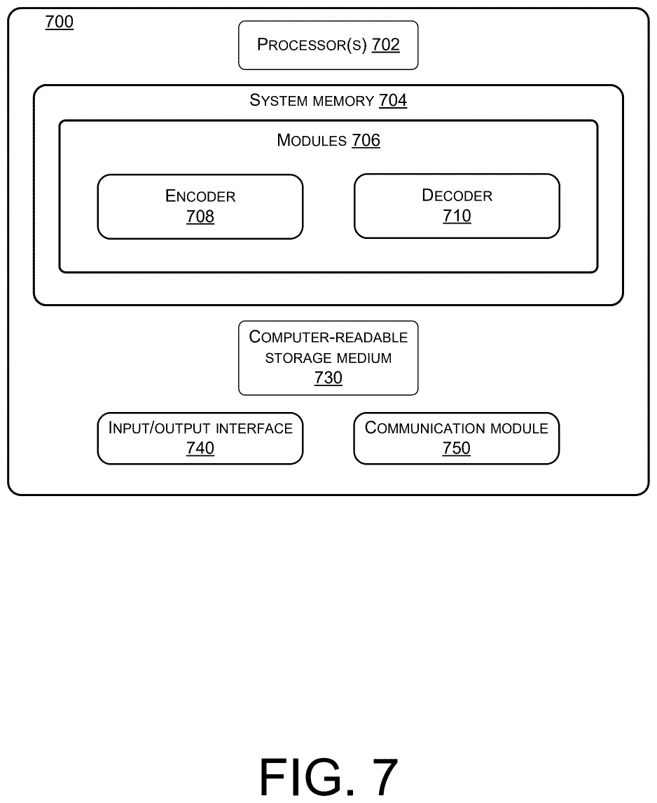

In accordance with the H.264/AVC (Advanced Video Coding), H.265/HEVC (High Efficiency Video Coding), Versatile Video Coding (“VVC”) standards, and successor standards currently in draft status such as H.267, a computing system includes at least one or more processors and a computer-readable storage medium communicatively coupled to the one or more processors. The computer-readable storage medium is a non-transient or non-transitory computer-readable storage medium, as defined subsequently with reference to FIG. 7, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by VVC and later standards, and operations of a decoder as described by VVC and later standards. Some of these encoder operations and decoder operations according to VVC and later standards are subsequently described in further detail, though these subsequent descriptions should not be understood as exhaustive of encoder operations and decoder operations according to VVC and later standards. Subsequently, a “VVC and later standard encoder” and a “VVC and later standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC and later standard encoder and a VVC and later standard decoder further include computer-readable instructions stored on a computer-readable storage medium which are executable by one or more processors of a computing system to configure the one or more processors to perform operations not specified by VVC and later standards. A VVC and later standard encoder should not be understood as limited to operations of a reference implementation of an encoder, but including further computer-readable instructions configuring one or more processors of a computing system to perform further operations as described herein. A VVC and later standard decoder should not be understood as limited to operations of a reference implementation of a decoder, but including further computer-readable instructions configuring one or more processors of a computing system to perform further operations as described herein.

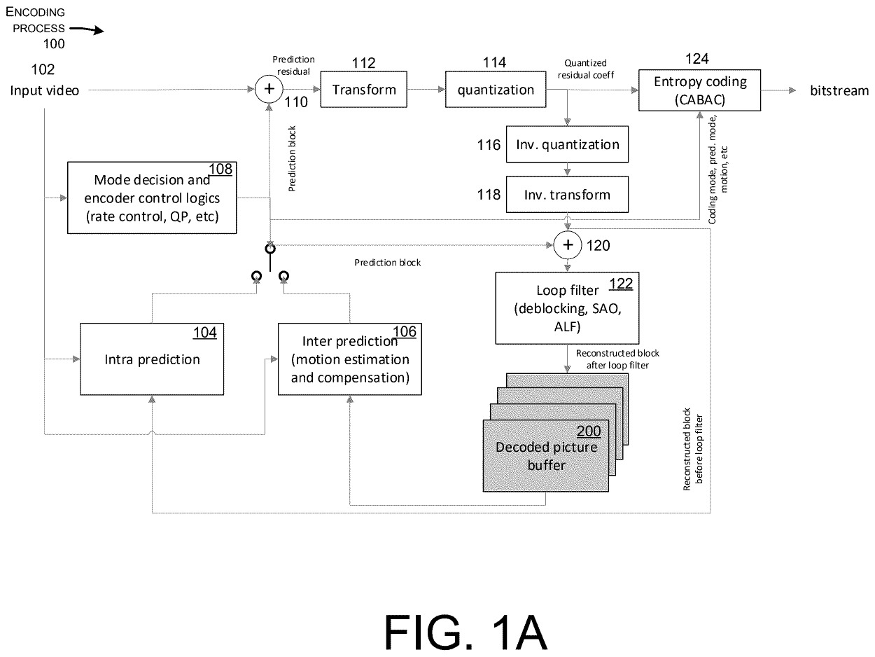

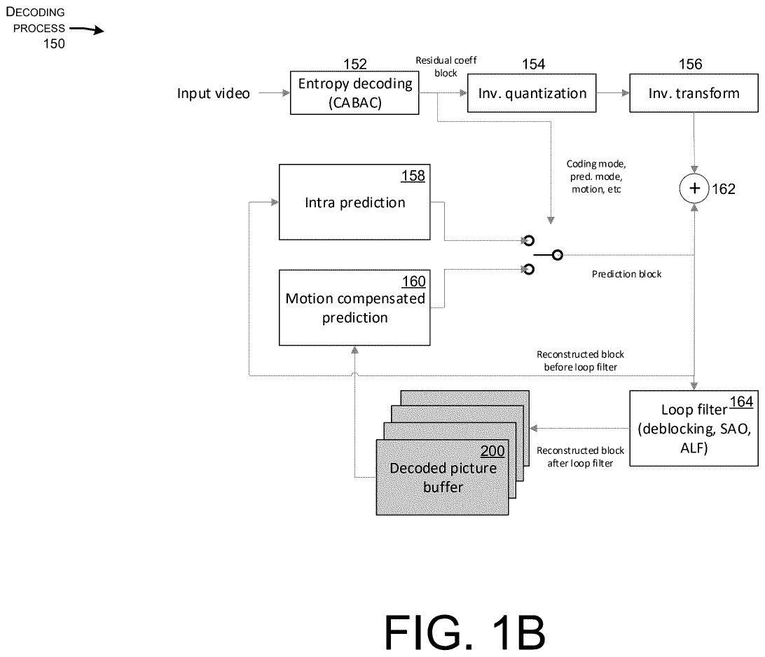

FIGS. 1A and 1B illustrate example block diagrams of, respectively, an encoding process 100 and a decoding process 150 according to an example embodiment of the present disclosure.

In an encoding process 100, a VVC and later standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC and later standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC and later standard encoder encodes a picture (a picture being encoded being called a “current picture,” as distinguished from any other picture received from an image source 102) by configuring one or more processors of a computing system to partition the original picture into units and subunits according to a partitioning structure. A VVC and later standard encoder configures one or more processors of a computing system to subdivide a picture into macroblocks (“MBs”) each having dimensions of 16×16 pixels, which may be further subdivided into partitions. A VVC and later standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC and later standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC and later standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC and later standard encoder configures one or more processors of a computing system to encode color information of a picture at a lower resolution than the input picture, storing the color information in fewer bits than the input picture.

Furthermore, a VVC and later standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to VVC and later standards. Motion information corresponding to a PU may describe motion prediction as encoded by a VVC and later standard encoder as described herein.

A VVC and later standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC and later standard encoder configures one or more processors of a computing system to code a CU to include reference indices to identify, for reference of a VVC and later standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC and later standard encoder configures one or more processors of a computing system to code each current block of a picture individually, outputting a prediction block for each. According to VVC and later standards, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC and later standard encoder configures one or more processors of a computing system to send coding parameter sets such as coding mode (i.e., intra or inter prediction), a mode of intra prediction or a mode of inter prediction, and motion information to an entropy coder 124 (as described subsequently).

VVC and later standards provide semantics for recording coding parameter sets for a CU. For example, with regard to the above-mentioned coding parameter sets, pred_mode_flag for a CU is set to 0 for an inter-coded block, and is set to 1 for an intra-coded block; general merge flag for a CU is set to indicate whether merge mode is used in inter prediction of the CU; inter_affine_flag and cu_affine_type_flag for a CU are set to indicate whether affine motion compensation is used in inter prediction of the CU; mvp_10_flag and mvp_11_flag are set to indicate a motion vector index in list 0 or in list 1, respectively; and ref_idx_10 and ref_idx_11 are set to indicate a reference picture index in list 0 or in list 1, respectively. It should be understood that VVC and later standards include semantics for recording various other information, flags, and options which are beyond the scope of the present disclosure.

A VVC and later standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC and later standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC and later standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

A VVC and later standard encoder can select one of three transform types: Discrete Cosine Transform 2 (“DCT-II”), Discrete Cosine Transform 8 (“DCT-VIII”), and Discrete Sine Transform 7 (“DST-VII”). This selection of one of multiple transform types is referred to as Multiple Transform Selection (“MTS”). A flag at the CU level is signaled to indicate whether MTS is applied or not. An additional two flags are signaled to indicate which transform type is selected (each an “MTS index”) for the horizontal direction and for the vertical direction respectively.

Sub-blocks of CUs, such as PUs and TBs, can be arranged in any combination of sub-block dimensions as described above. A VVC and later standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC and later standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC and later standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC and later standard encoder further implements an adder 120. One or more processors of a computing system are configured to perform an addition operation by adding a prediction block and a reconstructed residual, outputting a reconstructed block.

A VVC and later standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC and later standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC and later standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a SPS found in a sequence of multiple pictures); and output the coded block.

A VVC and later standard encoder configures one or more processors of a computing system to output a coded picture, made up of coded blocks from the entropy coder 124. The coded picture is output to a transmission buffer, where it is ultimately packed into a bitstream for output from the VVC and later standard encoder. The bitstream is written by one or more processors of a computing system to a non-transient or non-transitory computer-readable storage medium of the computing system, for transmission.

In a decoding process 150, a VVC and later standard decoder configures one or more processors of a computing system to receive, as input, one or more coded pictures from a bitstream.

A VVC and later standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC and later standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC and later standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC and later standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC and later standard decoder configures one or more processors of a computing system to perform motion compensated prediction 160 using a reference picture from a DPB 200. The motion compensated prediction 160 thereby generates a prediction signal.

A VVC and later standard decoder further implements an adder 162. The adder 162 configures one or more processors of a computing system to perform an addition operation on the reconstructed residuals and the prediction signal, thereby outputting a reconstructed block.

A VVC and later standard decoder further implements a loop filter 164. One or more processors of a computing system are configured to apply a loop filter, such as a deblocking filter, a SAO filter, and ALF to a reconstructed block, outputting a filtered reconstructed block.

A VVC and later standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC and later standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC and later standard encoder and a VVC and later standard decoder each implements motion prediction coding in accordance with VVC and later standard specifications. A VVC and later standard encoder and a VVC and later standard decoder each configures one or more processors of a computing system to generate a reconstructed picture based on a previous reconstructed picture of a DPB according to motion compensated prediction as described by VVC and later standards, wherein the previous reconstructed picture serves as a reference picture in motion compensated prediction as described herein.

Enhanced Compression Model (“ECM”) employs some additional primary transforms. In ECM, Direct Cosine Transform 5 (“DCT5”), Direct Sine Transform 4 (“DST4”), Direct Sine Transform 1 (“DST1”), and identity transform (“IDT”) are also employed. Additionally, the set of transforms available for selection (the MTS set) is made dependent on the transform unit (“TU”) size and intra mode information (e.g. intra prediction angular mode).

With respect to MTS for intra prediction blocks, according to the ECM-19.0 design, 5 different classes are considered for each of 16 different TU sizes. This results in 80 different classes being considered, wherein for each of the 16 different TU sizes, one of the 5 classes is considered depending on intra-mode information. The MTS candidates for each class are listed according to Table 1 below:

| class | candidate 1 | candidate 2 | candidate 3 | candidate 4 | candidate 5 | candidate 6 |
|---|---|---|---|---|---|---|
| 0 | {DST4, DST4} | {DST1, DST1} | {DST4, DCT5} | {DST1, DST4} | {DST7, DST4} | {DCT5, DCT5} |
| 1 | {DST4, DST4} | {DCT8, DST4} | {DST7, DCT5} | {DST1, DCT5} | {DCT8, DCT8} | {DST4, DST7} |
| 2 | {DST4, DST4} | {DCT8, DCT5} | {DST4, DCT5} | {DST1, DCT5} | {DCT8, DST4} | {DST1, DST4} |
| 3 | {DST4, DST4} | {DCT8, DST4} | {DST4, DCT8} | {DST4, DCT5} | {DCT5, DCT5} | {DST1, DST4} |
| 4 | {DST4, DST4} | {DCT5, DCT5} | {DCT8, DST4} | {DST4, DST1} | {DCT5, DCT8} | {DCT5, DST4} |
| 5 | {DST4, DST4} | {DCT5, DCT5} | {DST4, DST1} | {DST1, DST4} | {DCT5, DST4} | {DST1, DST1} |
| 6 | {DST4, DST4} | {DCT5, DCT5} | {DST4, DCT5} | {DCT8, DCT5} | {DCT8, DST4} | {DST1, DST4} |
| 7 | {DST4, DST4} | {DCT8, DCT5} | {DST4, DCT5} | {DST1, DCT5} | {DCT5, DCT5} | {DST1, DST4} |
| 8 | {DST4, DST4} | {DCT8, DCT5} | {DCT5, DST7} | {DST4, DCT5} | {DST1, DCT5} | {DST1, DST4} |
| 9 | {DST4, DST4} | {DCT5, DCT5} | {DST4, DST1} | {DST1, DST4} | {DCT8, DST4} | {DCT5, DCT8} |
| 10 | {DST4, DST7} | {DCT5, DCT5} | {DCT5, DST4} | {DST1, DST1} | {DST7, DCT5} | {DST7, DST4} |
| 11 | {DST4, DST7} | {DCT8, DCT5} | {DCT5, DST7} | {DST1, DST4} | {DCT5, DCT5} | {DST4, DST4} |
| 12 | {DCT5, DST4} | {DST4, DCT5} | {DCT8, DCT5} | {DST1, DCT5} | {DCT5, DCT5} | {DST4, DST4} |
| 13 | {DST4, DCT5} | {DCT5, DST7} | {DCT8, DCT5} | {DST1, DST7} | {DCT5, DCT5} | {DST4, DST4} |
| 14 | {DST4, DST7} | {DCT5, DST4} | {DST4, DST1} | {DST1, DCT5} | {DCT8, DST4} | {DCT5, DCT8} |
| 15 | {DST4, DST4} | {DCT5, DCT5} | {DCT5, DST4} | {DST7, DCT5} | {DCT5, DST1} | {DST1, DCT5} |
| 16 | {DST4, DST7} | {DCT5, DCT5} | {DCT5, DST7} | {DCT8, DST7} | {DST4, DST4} | {DST1, DCT5} |
| 17 | {DST4, DCT5} | {DCT5, DST4} | {DCT8, DST4} | {DST1, DCT5} | {DCT5, DCT5} | {DST4, DST4} |
| 18 | {DST7, DST7} | {DCT5, DCT5} | {DCT8, DST7} | {DST1, DCT5} | {DCT5, DST4} | {DST4, DCT5} |
| 19 | {DST4, DST7} | {DCT5, DCT5} | {DCT5, DST4} | {DST4, DCT8} | {DCT8, DCT5} | {DST1, DST4} |
| 20 | {DST4, DST4} | {DST1, DST1} | {DST1, DST4} | {DST4, DST1} | {DCT5, DCT5} | {DST4, DCT5} |
| 21 | {DST4, DST4} | {DST1, DST1} | {DCT8, DCT5} | {DST4, DCT5} | {DCT8, DCT8} | {DST1, DST4} |
| 22 | {DST4, DCT5} | {DCT8, DST4} | {DCT8, DST1} | {DST1, DCT5} | {DCT8, DCT5} | {DCT5, DST4} |
| 23 | {DST4, DST4} | {DCT5, DCT5} | {DST4, DST1} | {DST1, DST4} | {DCT8, DST4} | {DST4, DCT8} |
| 24 | {DST4, DST4} | {DCT5, DCT5} | {DST4, DST1} | {DST1, DST4} | {DCT8, DST4} | {DCT5, DCT8} |
| 25 | {DST7, DST7} | {DCT5, DCT5} | {DST4, DST4} | {DST1, DST1} | {DCT5, DST4} | {DST4, DST1} |
| 26 | {DST7, DST7} | {DCT5, DCT5} | {DCT8, DCT5} | {DST1, DST7} | {DCT5, DST4} | {DST4, DST4} |
| 27 | {DST4, DCT5} | {DCT5, DST7} | {DCT8, DST7} | {DST1, DCT5} | {DCT8, DCT5} | {DST4, DST4} |
| 28 | {DST4, DST7} | {DST4, DCT5} | {DCT8, DST4} | {DCT5, DST7} | {DCT5, DCT5} | {DST1, DST4} |
| 29 | {DST7, DST4} | {DCT5, DCT5} | {DST4, DST1} | {DST1, DST4} | {DCT5, DST7} | {DST1, DST1} |
| 30 | {DST4, DST7} | {DCT5, DST4} | {DST7, DCT5} | {DST1, DST4} | {DCT5, DCT5} | {DST4, DST1} |
| 31 | {DST7, DST7} | {DCT5, DCT5} | {DCT8, DST7} | {DCT5, DST7} | {DST4, DST4} | {DST1, DCT5} |
| 32 | {DST4, DCT5} | {DCT5, DST7} | {DCT8, DST7} | {DST1, DST7} | {DCT5, DCT5} | {DST4, DST4} |
| 33 | {DST7, DST7} | {DCT5, DST7} | {DST4, DCT5} | {DST1, DST7} | {DCT5, DCT5} | {DST4, DST4} |
| 34 | {DST7, DST4} | {DCT5, DST7} | {DCT5, DST1} | {DST4, DCT5} | {DCT5, DCT5} | {DST1, DCT5} |
| 35 | {DST7, DST7} | {DCT5, DCT5} | {DCT5, DST7} | {DST1, DST7} | {DCT5, DST1} | {DST4, DST7} |
| 36 | {DST7, DST7} | {DCT5, DCT5} | {DCT5, DST7} | {DCT8, DST7} | {DST4, DCT5} | {DST1, DST7} |
| 37 | {DST7, DST7} | {DCT5, DCT5} | {DCT5, DST7} | {DCT8, DCT5} | {DST4, DCT5} | {DST1, DST7} |
| 38 | {DST7, DST7} | {DCT5, DST7} | {DST1, DST7} | {DCT8, DST7} | {DCT5, DCT5} | {DST4, DCT5} |
| 39 | {DST4, DST7} | {DCT5, DCT5} | {DCT5, DST7} | {DST7, DCT5} | {DCT8, DST7} | {DST7, DCT8} |
| 40 | {DST7, DST4} | {DCT5, DCT5} | {DST4, DST1} | {DST1, DST1} | {DCT5, DST7} | {DST4, DCT5} |
| 41 | {DST4, DST4} | {DCT5, DST4} | {DCT8, DST7} | {DST1, DCT5} | {DCT8, DCT5} | {DST1, DST1} |
| 42 | {DST7, DST7} | {DCT8, DCT5} | {DST4, DCT5} | {DST1, DST7} | {DST4, DST1} | {DST1, DCT5} |
| 43 | {DST4, DST7} | {DCT5, DCT5} | {DCT5, DST7} | {DST4, DST1} | {DST7, DST4} | {DST4, DCT8} |
| 44 | {DST7, DST4} | (DCT5, DCT5} | {DST4, DCT5} | {DST1, DST1} | {DCT5, DST4} | {DST4, DCT8} |
| 45 | {DST7, DST7} | {DCT5, DCT5} | {DST4, DST1} | {DST1, DST7} | {DST4, DCT5} | {DST4, DST4} |
| 46 | {DST7, DST7} | {DCT5, DCT5} | {DCT5, DST4} | {DST1, DST7} | {DCT8, DCT5} | {DST4, DST4} |
| 47 | {DST4, DST7} | {DCT8, DCT5} | {DST4, DCT5} | {DST1, DST7} | {DCT8, DST7} | {DCT5, DST7} |
| 48 | {DST7, DST7} | {DST4, DCT5} | {DST4, DST1} | {DST1, DST4} | {DCT5, DCT5} | {DST4, DST7} |
| 49 | {DST7, DST7} | {DCT5, DCT5} | {DCT5, DST1} | {DST4, DCT5} | {DST7, DST4} | {DST1, DCT5} |
| 50 | {DST7, DST7} | {DST7, DCT5} | {DCT5, DST7} | {DST1, DST7} | {DST7, DST1} | {DCT5, DCT5} |
| 51 | {DST4, DST7} | {DCT5, DCT5} | {DCT5, DST7} | {DCT8, DST7} | {DST7, DCT5} | {DST1, DST7} |
| 52 | {DST7, DST7} | {DCT5, DCT5} | {DCT5, DST7} | {DCT8, DST7} | {DST4, DCT5} | {DST1, DST7} |
| 53 | {DST7, DST7} | {DCT5, DCT5} | {DCT5, DST7} | {DST1, DST7} | {DCT8, DST7} | {DST4, DST7} |
| 54 | {DST7, DST4} | {DST7, DCT5} | {DST7, DST1} | {DCT5, DST7} | {DCT5, DCT5} | {DST1, DST7} |
| 55 | {DST7, DST7} | {DCT5, DCT5} | {DST7, DCT5} | {DCT5, DST7} | {DCT5, DST1} | {DST1, DST7} |
| 56 | {DST7, DST7} | {DCT5, DCT5} | {DST7, DCT5} | {DCT5, DST7} | {DCT8, DST7} | {DST1, DST7} |
| 57 | {DST4, DST7} | {DCT5, DCT5} | {DCT5, DST7} | {DCT8, DST7} | {DCT8, DCT5} | {DST1, DST7} |
| 58 | {DST7, DST7} | {DCT5, DST7} | {DST4, DCT5} | {DST1, DST7} | {DCT8, DST7} | {DCT5, DCT5} |
| 59 | {DST7, DST7} | {DCT5, DCT5} | {DST7, DCT5} | {DCT5, DST7} | {DST7, DST1} | {DST1, DST7} |
| 60 | {DST4, DST4} | {DCT5, DCT5} | {DCT5, DST1} | {DST1, DST7} | {DST7, DST7} | {DST1, DST7} |
| 61 | {DST4, DST7} | {DCT5, DST7} | {DCT8, DST7} | {DST1, DCT5} | {DCT8, DCT5} | {DST4, DCT5} |
| 62 | {DST4, DST7} | {DCT5, DST7} | {DCT8, DST7} | {DST1, DCT5} | {DCT8, DCT5} | {DST4, DCT5} |
| 63 | {DST4, DST7} | {DCT5, DST4} | {DST4, DCT8} | {DST7, DCT5} | {DCT5, DST1} | {DST4, DST1} |
| 64 | {DST7, DST4} | {DCT5, DCT5} | {DCT8, DST7} | {DST4, DST1} | {DST4, DST7} | {DST1, DST4} |
| 65 | {DST7, DST7} | {DCT5, DCT5} | {DST7, DCT5} | {DST7, DST1} | {DCT5, DST4} | {DST1, DST7} |
| 66 | {DST7, DST7} | {DCT5, DCT5} | {DCT5, DST4} | {DCT8, DCT5} | {DST7, DCT5} | {DST4, DST4} |
| 67 | {DST4, DST7} | {DCT5, DCT5} | {DCT8, DST7} | {DST1, DST7} | {DCT5, DST7} | {DST4, DCT5} |
| 68 | {DST4, DST7} | {DCT5, DST7} | {DST7, DCT5} | {DST4, DST1} | {DCT5, DCT5} | {DST4, DCT8} |
| 69 | {DST7, DST4} | {DCT5, DCT5} | {DST7, DCT5} | {DCT5, DST7} | {DCT5, DST1} | {DST1, DST7} |
| 70 | {DST7, DST7} | {DCT5, DCT5} | {DST7, DCT5} | {DCT5, DST7} | {DST7, DST4} | {DST7, DST1} |
| 71 | {DST7, DST7} | {DCT5, DCT5} | {DST7, DCT5} | {DCT5, DST7} | {DCT8, DCT5} | {DST1, DST7} |
| 72 | {DST7, DST7} | {DCT5, DCT5} | {DCT8, DST7} | {DCT5, DST7} | {DST1, DST7} | {DST1, DCT5} |
| 73 | {DST7, DST7} | {DST7, DCT5} | {DCT5, DST7} | {DST4, DST7} | {DST7, DST1} | {DCT5, DCT5} |
| 74 | {DST7, DST7} | {DCT5, DCT5} | {DST7, DCT5} | {DCT5, DST7} | {DST7, DST1} | {DST1, DST7} |
| 75 | {DST7, DST7} | {DCT5, DCT5} | {DST7, DCT5} | {DCT5, DST7} | {DCT5, DST4} | {DST4, DCT5} |
| 76 | {DST7, DST7} | {DCT5, DCT5} | {DCT5, DST7} | {DST1, DST7} | {DCT8, DCT5} | {DST7, DCT5} |
| 77 | {DST7, DST7} | {DCT5, DCT5} | {DCT8, DST7} | {DCT5, DST7} | {DCT8, DCT5} | {DST7, DCT5} |
| 78 | {DST7, DST7} | {DCT5, DCT5} | {DST7, DCT5} | {DCT5, DST7} | {DST4, DST7} | {DST1, DST7} |
| 79 | {DST7, DST7} | {DCT5, DCT5} | {DST7, DCT5} | {DCT5, DST7} | {DST7, DST1} | {DST4, DST7} |

For each class, 1, 4, or 6 different transform pairs are considered. The number of intra MTS candidates are adaptively selected between the 1, 4, and 6 MTS candidates depending on the sum of the absolute value of the transform coefficients. That sum is compared against two fixed thresholds to determine the total number of allowed MTS candidates. If the sum of the absolute value of transform coefficients is smaller than or equal to a threshold 0, only 1 MTS candidate is allowed. If the sum of the absolute value of transform coefficients is greater than a threshold 0 and smaller than or equal to a threshold 1, 4 MTS candidates are allowed. Otherwise (sum greater than 1), 6 MTS candidates are allowed.

ECM provides a decoder-side intra mode derivation (“DIMD”) mode. Up to five intra prediction modes among angular modes are derived from the reconstructed neighbor samples, and those five predictors are combined with the planar mode predictor with the weights derived from a histogram of gradients.

ECM provides intra template matching prediction (“IntraTMP”), a special intra prediction mode that copies the best prediction block from the reconstructed part of the current frame, whose L-shaped template matches the current template. For a predefined search range, a VVC and later standard encoder configures one or more processors of a computing system to search for the most similar template to the current template in a reconstructed part of the current frame and use the corresponding block as a prediction block. The VVC and later standard encoder then configures one or more processors of a computing system to signal the usage of this mode, and the same prediction operation is performed at the decoder side. A block vector that indicates the displacement from the current block to the corresponding block is stored.

For blocks predicted via IntraTMP, a DIMD process is used on the prediction block to derive an intra mode that is used for transform selection. Specifically, a horizontal gradient Gₓ and a vertical gradient G_{y} are calculated for each predicted sample to build a Histogram of Gradients (“HoG”). Then, the intra prediction mode having the largest histogram amplitude values is used in the MTS transform set.

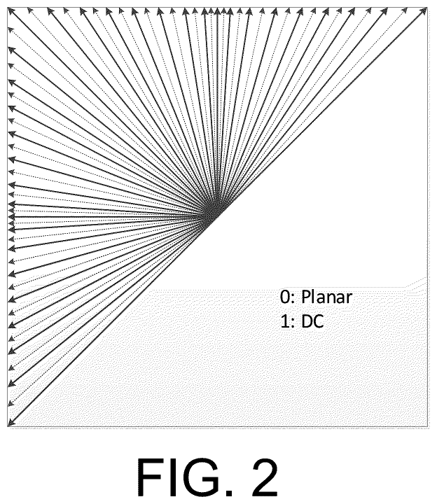

Angular intra prediction is a directional intra prediction method, which is extended from a prior implementation according to the HEVC standard. To capture the arbitrary edge directions presented in natural video, VVC and later standards extend the number of intra prediction angular modes from 33 (as used in HEVC) to 65. The 65 angular modes can be represented as index 2 to index 66 from bottom left to top right, as shown in FIG. 2.

For angular modes as shown in FIG. 2, a joint symmetry over the TU shape and intra prediction is considered. In the example shown, a mode i (i>34) having CTU shape A×B will be mapped to the same class corresponding to the mode j=(68−i) having CTU shape B×A. However, for each transform pair the order of the horizontal and vertical transform kernel is swapped. For example, a 16×4 block having mode 18 (horizontal prediction) and a 4×16 block having mode 50 (vertical prediction) are mapped to the same class, but with the vertical and horizontal transform kernels swapped. For the wide-angle modes the nearest conventional angular mode is used for the transform set determination. For example, mode 2 is used for all the modes between −2 and −14. Similarly, mode 66 is used for mode 67 to mode 80.

With respect to MTS for inter coded CUs (“inter MTS”), four candidates are used for every CU: {(DST7, DST7), (DST7, DCT8), (DCT8, DST7), (DCT8, DCT8)}. For the larger resolution sequences (width>1080), the maximum CU size for inter MTS usage is set to 32. This means that inter MTS is used for a CU having width<=32 and height<=32. For remaining sequences (smaller resolutions), the maximum CU size is set to 16. For 4-pt, 8-pt, and 16-pt transforms, the current MTS transform cores (DST7, DCT8) are replaced with separable Karhunen-Loeve transforms (“KLTs”).

With respect to decoder side intra mode derivation, when DIMD is applied, up to five intra modes are derived from the reconstructed neighbor samples, and those five predictors are combined with the non-directional predictor (planar or block vector based predictor) with the weights derived from an HoG. This HoG can be computed by applying horizontal and vertical Sobel filters on pixels in a template of width 3 around a block which do not fall into a different CTU. This HoG can also be modified depending on the availability of reconstructed samples. The region of decoded reference samples of a current luma CU (with dimensions W×H) can be extended towards the above-right side if available, up to W additional columns and extended towards the bottom-left side if available, up to H additional rows.

The decision between the non-directional modes is taken according to a template cost. Specifically, the block vectors of all adjacent and non-adjacent merge candidates are compared to planar prediction on the reconstructed template. The merge candidates may be coded in IntraTMP or in an intra block copy mode (“IBC”) described in further detail subsequently. The template cost (“SATD,” described in further detail subsequently) is used to select the best predictor among them.

According to ECM, intra block copy (“IBC”) mode is implemented as a block level coding mode. Herein, a VVC and later standard encoder configures one or more processors of a computing system to perform block matching (“BM”) to find the optimal block vector (or motion vector) for each CU. A block vector indicates the displacement from the current block to a reference block, which is already reconstructed inside the current picture.

For the DIMD application, the division operations in weight derivation are performed utilizing the same lookup table (“LUT”) based integerization scheme used by a Cross Component Linear Model mode (“CCLM”), described in further detail subsequently.

For example, the division operation in the orientation calculation Orient=G_{y}/Gₓ is computed by a LUT based scheme according to Equations 1 through 4 below:

$$x = Floor ( Log 2 ( {G}_{x} ) )$$

$$normDiff = ( ( {G}_{x} \text{<<} 4 ) \text{>>} x ) \& 15$$

$$x += ( 3 + ( normDiff != 0 ) ? 1 : 0 )$$

$$Orient = ( {G}_{y} * ( DivSigTable [ normDiff ] \vert 8 + ( 1 \text{<<} ( x - 1 ) ) ) \text{>>} x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

For a block of size W×H, the weight for each of the five derived modes is modified if either the above or left histogram has magnitudes twice as large as the other. Given that wDimdᵢ is the unmodified uniform weight of the DIMD selected as in the previously-discussed modified HoG computed by applying horizontal and vertical Sobel filters, if the above histogram is twice the left, then according to Equation 5:

$${w}_{i} ( x , y ) = w D i m {d}_{i} + {Δ}_{i} - 2 {Δ}_{i} \frac{y}{( H - 1 )} .$$

If the left histogram is twice the above, then according to Equation 6:

$${w}_{i} ( x , y ) = w D i m {d}_{i} + {Δ}_{i} - 2 {Δ}_{i} \frac{x}{( W - 1 )}$$

In these equations, Δᵢ can be pre-defined and set to 10. Derived intra modes are included into a primary list of intra most probable modes (“MPM”), so the DIMD process is performed before the MPM list is constructed. The primary derived intra mode of a DIMD block is stored with a block and is used for MPM list construction of the neighboring blocks.

According to VVC and later standards, a relationship between the luma component and the chroma components is represented by a Cross Component Linear Model (“CCLM”). The linear model is composed of the parameters a and B, whose values are derived based on reconstructed samples that are adjacent to the current block at both encoder and decoder side without explicit signaling.

As described above, ECM provides MTS for intra coded blocks supporting DST7, DCT8, DCT5, DST4, DST1, and IDT. However, unlike intra-coded blocks, the MTS for inter coded blocks are limited to DST7 and DCT8. This limitation of only two selections for inter coded blocks may reduce the coding performance for inter coded blocks. Hence, improvements to MTS for inter coded blocks may improve performance. Therefore, example embodiments of the present disclosure provide supporting additional transform cores (e.g., DCT5, DST4, DST1, and IDT) for inter coded blocks. This may be performed by applying a DIMD process to inter prediction samples or residual samples to derive an intra prediction angular mode. This can include calculating a horizontal and vertical gradient; building a histogram of gradients; and selecting an intra prediction angular mode having a highest amplitude.

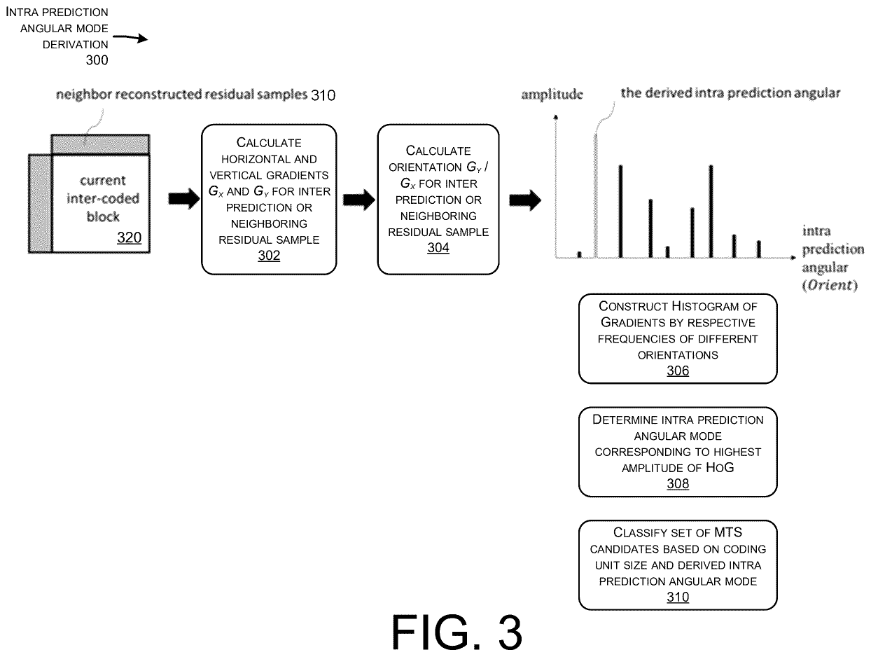

FIG. 3 illustrates intra prediction angular mode derivation 300 applied to inter prediction samples or residual samples to derive an intra prediction angular mode according to example embodiments of the present disclosure.

At a step 302, a VVC and later standard encoder and a VVC and later standard decoder configure one or more processors of a computing system to calculate a horizontal gradient Gₓ and a vertical gradient G_{y} for an inter prediction sample or a neighboring residual sample of an inter coded block.

According to an example embodiment, the inter prediction samples of current inter coded blocks 320 are used to calculate gradients. In another example embodiment, neighboring reconstructed residual samples 310 (illustrated as shaded blocks) are used to calculate gradients.

At a step 304, the VVC and later standard encoder and the VVC and later standard decoder configure the one or more processors to calculate an orientation of an inter prediction sample or a neighboring residual sample by dividing the vertical gradient G_{y} by the horizontal gradient Gₓ by a LUT-based integerization (as described above).

At a step 306, the VVC and later standard encoder and the VVC and later standard decoder configure the one or more processors to construct a Histogram of Gradients (“HoG”) by respective frequencies of different orientations of inter prediction samples or neighboring residual samples. Each different orientation of inter prediction samples or neighboring residual samples is quantized to align with a different intra prediction angular mode.

At a step 308, the VVC and later standard encoder and the VVC and later standard decoder configure the one or more processors to determine an intra prediction angular mode corresponding to a highest amplitude of the HoG.

At a step 310, the VVC and later standard encoder and the VVC and later standard decoder configure the one or more processors to classify a set of MTS candidates based on coding tree unit size and the derived intra prediction angular mode.

Similar to MTS candidate classification for intra-coded blocks as described above, the derived intra prediction angular mode from step 308, and CTU size, can be used to classify the inter-coded blocks into one of 80 classes. Then, MTS candidates in that class can be used for the inter-coded blocks.

As described above, VVC and later standards provide the same four inter MTS candidates for all inter coded CUs. In contrast, according to example embodiments of the present disclosure, the classified set of intra MTS candidates can replace the inter MTS candidates, or the classified set of intra MTS candidates can be included in the index of inter MTS candidates.

According to some embodiments, the four inter MTS candidates {(DST7, DST7), (DST7, DCT8), (DCT8, DST7), (DCT8, DCT8)} are replaced by the classified MTS candidates. Similar to intra coded blocks, the number of allowed candidates is determined based on the sum of the absolute value of transform coefficients. That is, if the sum of the absolute value of transform coefficients is smaller than or equal to threshold 0, only 1 classified MTS candidate is allowed. Otherwise, if the sum of the absolute value of transform coefficients is greater than threshold 0 and smaller than or equal to threshold 1, 4 classified MTS candidates are allowed. Otherwise, 6 classified MTS candidates are allowed.

According to another example embodiment, the classified MTS candidates are included in the index of inter MTS candidates at TU-level for inter coded blocks. Table 2 shows 6 classified MTS candidates included after the inter MTS candidates at TU-level for an MTS index.

| MTS index | MTS candidates |
|---|---|
| 0 | {DST7, DST7} |
| 1 | {DST7, DCT8} |
| 2 | {DCT8, DST7} |
| 3 | {DCT8, DCT8} |
| 4 | candidate 1 from the class |
| 5 | candidate 2 from the class |
| 6 | candidate 3 from the class |
| 7 | candidate 4 from the class |
| 8 | candidate 5 from the class |
| 9 | candidate 6 from the class |

According to another example embodiment, the 6 classified MTS candidates are included before the inter MTS candidates at TU-level for an MTS index, as shown in Table 3.

| MTS index | MTS candidates |
|---|---|
| 0 | candidate 1 from the class |
| 1 | candidate 2 from the class |
| 2 | candidate 3 from the class |
| 3 | candidate 4 from the class |
| 4 | candidate 5 from the class |
| 5 | candidate 6 from the class |
| 6 | {DST7, DST7} |
| 7 | {DST7, DCT8} |
| 8 | {DCT8, DST7} |
| 9 | {DCT8, DCT8} |

The candidates 1-6 in Tables 2 and 3 are indicated by reference to Table 1. For example, if the class is class 0, then candidates 1-6 are {DST4, DST4}, {DST1, DST1}, {DST4, DCT5}, {DST1, DST4}, {DST7, DST4} and {DCT5, DCT5}.

According to another example embodiment, the number of classified MTS candidates included in the index of inter MTS candidates at TU-level is determined according to the sum of the absolute value of transform coefficients. Similarly to above, if the sum is less than or equal to threshold 0, only 1 classified MTS candidate is included in the index; if the sum is greater than 0 and smaller than or equal to threshold 1, 4 classified MTS candidates are included in the index; otherwise 6 classified MTS candidates are included in the index.

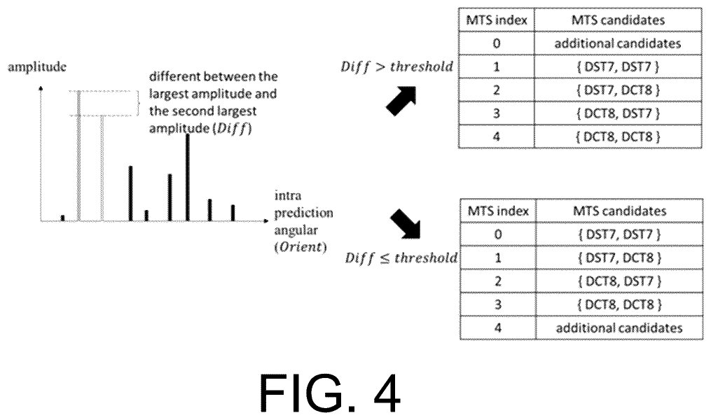

According to a further embodiment, only 1 classified MTS candidate is included in the index. This additional MTS candidate is inserted prior to or after the existing MTS candidates at TU-level for an MTS index according to the amplitude of the intra prediction angular mode. Specifically, if the difference between the largest histogram amplitude and the second largest histogram amplitude is greater than a pre-defined threshold, the additional MTS candidate is included in the index before the existing inter MTS candidates at TU-level for an MTS index. Otherwise, if the difference between the largest histogram amplitude and the second largest histogram amplitude is less than or equal to a pre-defined threshold, the additional MTS candidate is included after the existing inter MTS candidates at TU-level for an MTS index. FIG. 4 illustrates adding additional MTS candidates at TU-level according to amplitude; the pre-defined threshold can be an integer number and can be based on CTU size, as shown.

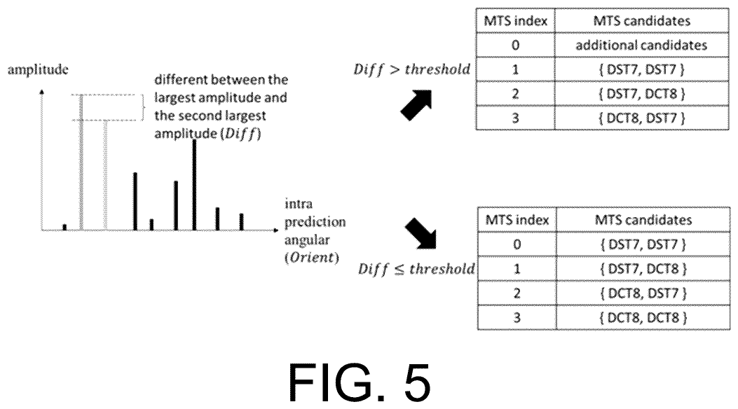

According to another embodiment as shown in FIG. 5, one of the inter MTS candidates is replaced by the classified MTS candidate at TU-level according to the amplitude of the intra prediction angular mode. Specifically, if the difference between the largest histogram amplitude and the second largest histogram amplitude is greater than a pre-defined threshold, the {DCT8, DCT8} is replaced by the classified MTS candidate at TU-level. Otherwise, if the difference between the largest histogram amplitude and the second largest histogram amplitude is less than or equal to a pre-defined threshold, the candidates remain the same. In some such examples, the replaced inter MTS candidate can be one of {(DST7, DST7), (DST7, DCT8), (DCT8, DST7), (DCT8, DCT8)}.

According to some example embodiments illustrated by FIGS. 4 and 5, rather than comparing the difference between the largest amplitude and the second largest amplitude, the ratio between the largest amplitude and the second largest amplitude is compared

$$( i . e . , ratio = \frac{largest amplitude}{second largest amplitude} ) .$$

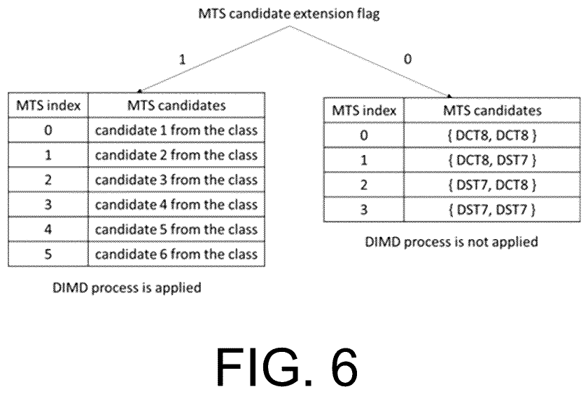

According to further embodiments, a TU-level flag can be signaled to indicate whether the DIMD process was applied to derive intra prediction angular mode and to derive additional MTS candidates. If the TU-level flag indicates that DIMD process was applied to derive intra prediction angular mode, an index may be signaled to indicate which classified MTS candidate was used. If the TU-level flag indicates that the DIMD process is not applied, the existing inter MTS candidates are used. FIG. 6 illustrates signaling a TU-level flag to indicate whether a DIMD process has been applied to inter coded blocks. When the DIMD process is applied to the inter-coded blocks, the number of MTS candidates may be dependent on the sum of the absolute value of the transform coefficients.

Further exemplary embodiments apply the disclosed methods to non-intra coded blocks such as intraTMP coded blocks, IBC coded blocks, and palette mode coded blocks.

The aforementioned embodiments can be freely combined. Persons skilled in the art will appreciate that all of the above aspects of the present disclosure may be implemented concurrently in any combination thereof, and all aspects of the present disclosure may be implemented in combination as yet another embodiment of the present disclosure.

FIG. 7 illustrates an example system 700 for implementing the processes and methods described above for implementing multiple transform selection for inter coded blocks.

The techniques and mechanisms described herein may be implemented by multiple instances of the system 700 as well as by any other computing device, system, and/or environment. The system 700 shown in FIG. 7 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 700 may include one or more processors 702 and system memory 704 communicatively coupled to the processor(s) 702. The processor(s) 702 may execute one or more modules and/or processes to cause the processor(s) 702 to perform a variety of functions. In some embodiments, the processor(s) 702 may include a central processing unit (“CPU”), a graphics processing unit (“GPU”), both CPU and GPU, or other processing units or components known in the art. Additionally, each of the processor(s) 702 may possess its own local memory, which also may store program modules, program data, and/or one or more operating systems.

Depending on the exact configuration and type of the system 700, the system memory 704 may be volatile, such as RAM, non-volatile, such as ROM, flash memory, miniature hard drive, memory card, and the like, or some combination thereof. The system memory 704 may include one or more computer-executable modules 706 that are executable by the processor(s) 702.

The modules 706 may include, but are not limited to, one or more of an encoder 708 and a decoder 710.

The encoder 708 may be a VVC and later standard encoder implementing any, some, or all aspects of example embodiments of the present disclosure as described above, and executable by the processor(s) 702 to configure the processor(s) 702 to perform operations as described above.

The decoder 710 may be a VVC and later standard encoder implementing any, some, or all aspects of example embodiments of the present disclosure as described above, executable by the processor(s) 702 to configure the processor(s) 702 to perform operations as described above.

The system 700 may additionally include an input/output (“I/O”) interface 740 for receiving image source data and bitstream data, and for outputting reconstructed pictures into a reference picture buffer or DPB and/or a display buffer. The system 700 may also include a communication module 750 allowing the system 700 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 730, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-7. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
deriving an intra prediction angular mode from at least one of an inter prediction sample or a neighboring residual sample of an inter coded block; and
classifying a set of multiple transform selection (“MTS”) candidates based on the intra prediction angular mode and a coding tree unit size.

2. The computing system of claim 1, wherein the operations further comprise:
calculating a horizontal gradient and a vertical gradient for the inter prediction sample or the neighboring residual sample; and
calculating an orientation of the inter prediction sample or the neighboring residual sample by a division operation based on the horizontal gradient and the vertical gradient;
wherein the division operation comprises lookup table-based integrization.

3. The computing system of claim 2, wherein the operations further comprise constructing a Histogram of Gradients by respective frequencies of different orientations of inter prediction samples or neighboring residual samples; and
wherein deriving an intra prediction angular mode comprises determining an intra prediction angular mode corresponding to a highest amplitude of the Histogram of Gradients.

4. The computing system of claim 1, wherein the operations further comprise replacing one or more inter MTS candidates with one or more of the set of MTS candidates at transform unit (“TU”) level for an MTS index.

5. The computing system of claim 4, wherein one or more of the set of MTS candidates consists of one MTS candidate, based on sum of absolute value of transform coefficients being either less than or equal to 0 or greater than 0.

6. The computing system of claim 4, wherein one inter MTS candidate is replaced with one MTS candidate of the set of MTS candidates, and a difference between, or a ratio of, a largest amplitude and a second largest amplitude of the Histogram of Gradients is greater than a threshold.

7. The computing system of claim 4, wherein the operations further comprise signaling an MTS index replaced at TU-level in a bitstream associated with a video sequence.

8. The computing system of claim 4, wherein the operations further comprise receiving a bitstream associated with a video sequence comprising an MTS index replaced at TU-level.

9. The computing system of claim 1, wherein the operations further comprise adding one or more of the set of MTS candidates to inter MTS candidates at transform unit (“TU”)-level for an MTS index.

10. The computing system of claim 9, wherein one or more of the set of MTS candidates consists of one MTS candidate, based on sum of absolute value of transform coefficients being either less than or equal to 0 or greater than 0.

11. The computing system of claim 9, wherein the one or more of the set of MTS candidates are included before inter MTS candidates at TU-level for an MTS index.

12. The computing system of claim 11, wherein a difference between, or a ratio of, a largest amplitude and a second largest amplitude of the Histogram of Gradients is greater than a threshold.

13. The computing system of claim 9, wherein the one or more of the set of MTS candidates are included after of inter MTS candidates at TU-level for an MTS index.

14. The computing system of claim 13, wherein a difference between, or a ratio of, a largest amplitude and a second largest amplitude of the Histogram of Gradients is less than or equal to a threshold.

15. The computing system of claim 9, wherein the operations further comprise signaling an MTS index at TU-level in a bitstream associated with a video sequence.

16. The computing system of claim 9, wherein the operations further comprise receiving a bitstream associated with a video sequence comprising an MTS index at TU-level.

17. The computing system of claim 1, wherein the operations further comprise:
signaling a transform unit (“TU”)-level flag in a bitstream associated with a video sequence indicating derivation of the intra prediction angular mode.

18. The computing system of claim 1, wherein the operations further comprise:
receiving a bitstream associated with a video sequence comprising a TU-level flag indicating derivation of the intra prediction angular mode.

19. A method of storing a bitstream associated with a video sequence, the method comprising:
generating a bitstream comprising:
a multiple transform selection (“MTS”) index indicating an MTS candidate replacing an inter MTS candidate in TU-level or included in an index of inter MTS candidates at TU-level; and
storing the bitstream in a non-transitory computer-readable storage medium.

20. A method of storing a bitstream associated with a video sequence, the method comprising:
generating a bitstream comprising a TU-level flag indicating derivation of the intra prediction angular mode; and
storing the bitstream in a non-transitory computer-readable storage medium.
